(19) United States
(12) Patent Application Publication
(10) Pub. No.: US 2010/0205036 A1
(43) Pub. Date: Aug. 12, 2010

(54) Apparatus, Method and User Interface for Presenting Advertisements

(76) Inventors: Rob Van Der Haar, Helsinki (FI); Laura Majava, Lahti (FI); Anna Nilsson, Helsinki (FI)

Correspondence Address: Hollingsworth & Funk, 8500 Normandale Lake Blvd., Suite 320, Minneapolis, MN, 55437, US

(21) Appl. No.: 12/368,747

(22) Filed: Feb. 10, 2009

(51) Int. Cl. G06Q 10/00; G06Q 30/00; G06F 3/033

(52) U.S. Cl. 705/10; 715/863; 705/14.64

(57) ABSTRACT

An apparatus comprising a controller configured to provide a first advertisement statement; receive a motion signal; and provide a second advertisement statement in response to receipt of said motion signal is provided.

### FIELD

The present application relates to a user interface, an apparatus and a method for presenting an advertisement, and in particular to a user interface, an apparatus and a method for presenting an advertisement in response to gesture input.

### BACKGROUND

More and more electronic devices such as mobile phones, MP3 players, Personal Digital Assistants (PDAs) and computers both laptops and desktops are becoming more and more advanced with complicated graphical user interfaces. One consequence of this is that many companies and service providers would like to place advertisements through the graphical user interface. As the displays are advanced the devices are able to present rather stylish and advanced advertisements.

One drawback is that a user easily gets accustomed to a displayed advertisement and as such the advertisement loses its effect as it no longer catches the user's attention.

Some solutions exist to change the advertisement and the most common is to switch advertisement every time a page is loaded or displayed. As a whole new page is being loaded the user most often only checks for the new relevant information and ignores the advertisement. Another drawback is that if a user wants to see more offers he has to download a complete new page which both takes time and wastes bandwidth.

An apparatus that allows an efficient switching of advertisements would thus be useful in modern day society

### SUMMARY

On this background, it would be advantageous to provide a user interface, an apparatus and a method that overcomes or at least reduces the drawbacks indicated above by providing an apparatus, a method, a computer readable medium and a user interface according to the claims.

Further objects, features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application is used according to an embodiment;

FIG. 2 is a view of an apparatus according to an embodiment;

FIG. 3 is a block diagram illustrating the general architecture of an apparatus of FIG. 2 in accordance with the present application;

FIGS. 4a, b and c are views of an apparatus according to an embodiment;

FIGS. 5a and b are views of an apparatus according to an embodiment;

FIGS. 6a, b, c and d are views of an apparatus according to an embodiment; and

FIG. 7 is a flow chart describing a method according to an embodiment of the application.

### DETAILED DESCRIPTION

In the following detailed description, the user interface, the apparatus, the method and the software product according to the teachings for this application in the form of a cellular/mobile phone will be described by the embodiments. It should be noted that although only a mobile phone is described the teachings of this application can also be used in any electronic device such as in portable electronic devices such as laptops, PDAs, mobile communication terminals, electronic books and notepads and other electronic devices offering access to information.

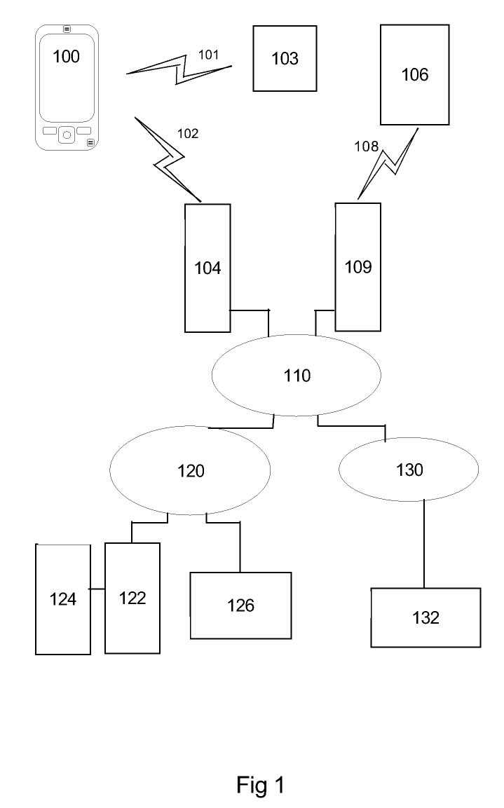

FIG. 1 illustrates an example of a cellular telecommunications system in which the teachings of the present application may be applied. In the telecommunication system of FIG. 1, various telecommunications services such as cellular voice calls, www or Wireless Application Protocol (WAP) browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through Radio Frequency (RF) links 102, 108 via base stations 104, 109. The mobile telecommunications network 110 may be in compliance with any commercially available mobile telecommunications standard, such as Group Spéciale Mobile (GSM), Universal Mobile Telecommunications System (UMTS), Digital Advanced Mobile Phone system (D-AMPS), The code division multiple access standards (CDMA and CDMA2000), Freedom Of Mobile Access (FOMA), and Time Division-Synchronous Code Division Multiple Access (TD-SCDMA).

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 as is commonly known by a skilled person. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, a Radio Standard link for example an RS-232 serial link, etc. The local devices 103 can for example be various sensors that can communicate measurement values to the mobile terminal 100 over the local link 101.

A computer such as a laptop or desktop can also be connected to the network both via a radio link such as a WiFi link, which is the popular term for a radio frequency connection using the WLAN (Wireless Local Area Network) standard IEEE 802.11.

It should be noted that the teachings of this application are also capable of being utilized in an internet network of which the telecommunications network described above may be a part of.

As is commonly known the internet is a global system of interconnected computer networks that interchange data by packet switching using the standardized Internet Protocol Suite (TCP/IP). It is a “network of networks” that consists of millions of private and public, academic, business, and government networks of local to global scope that are linked by copper wires, fiber-optic cables, wireless connections, and other technologies.

The Internet carries various information resources and services, such as electronic mail, online chat, online gaming, file transfer and file sharing, and the inter-linked hypertext documents and other resources of the World Wide Web (WWW).

It should be noted that even though the teachings herein are described solely to wireless networks it is in no respect to be limited to wireless networks as such, but it to be understood to be usable in the Internet or similar networks.

It should thus be understood that an apparatus according to the teachings herein may be a mobile communications terminal, such as a mobile telephone, a personal digital assistant, a laptop as well as a stationary device such as a desktop computer or a server.

The apparatus can also be a digital camera having communicative means. Such communicative means can be a serial connection through which it is capable of communicating with another device such as a computer.

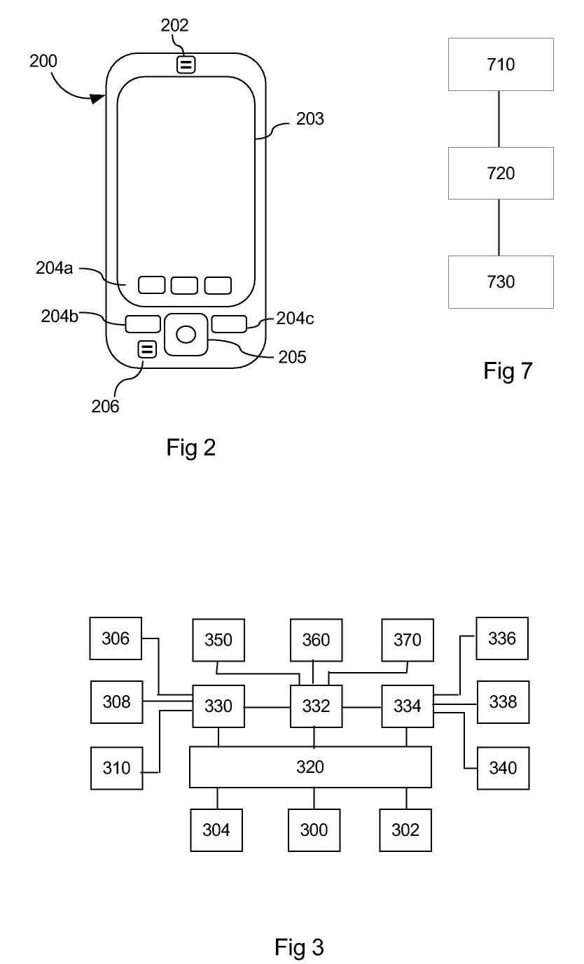

An embodiment 200 of the mobile terminal 100 is illustrated in more detail in FIG. 2. The mobile terminal 200 comprises a speaker or earphone 202, a microphone 206, a main or first display 203 and a set of keys 204 which may include a keypad 204a of common ITU-T type (alpha-numerical keypad representing characters “0”-“9”, “*” and “#”) and certain other keys such as soft keys 204b, 204c and a joystick 205 or other type of navigational input device.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as Random Access Memory (RAM), Read Only Memory (ROM), Electrically Erasable Programmable Read-Only Memory (EEPROM), flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a message text editor 350, a notepad application 360, as well as various other applications 370, such as applications for voice calling, video calling, sending and receiving messages such as Short Message Service (SMS), Multimedia Message Service (MMS) or email, web browsing, an instant messaging application, a phone book application, a calendar application, a control panel application, a camera application, one or more video games, etc. It should be noted that two or more of the applications listed above may be executed as the same application.

The MMI 334 also includes one or more hardware controllers, which together with the MMI drivers cooperate with the first display 336/203, and the keypad 338/204 as well as various other Input/Output devices such as microphone, speaker, vibrator, ringtone generator, LED indicator, etc.

The MMI 334 also includes a motion sensor 340. In one embodiment the motion sensor 340 is implemented by an accelerometer. The motion sensor 340 is coupled to the controller 300 for providing motion signals to the controller 300.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, Analog to Digital and Digital to Analog (AD/DA) converters, etc.

The mobile terminal also has a Subscriber Identity Module (SIM) card 304 and an associated reader. As is commonly known, the SIM card 304 comprises a processor as well as local work and data memory.

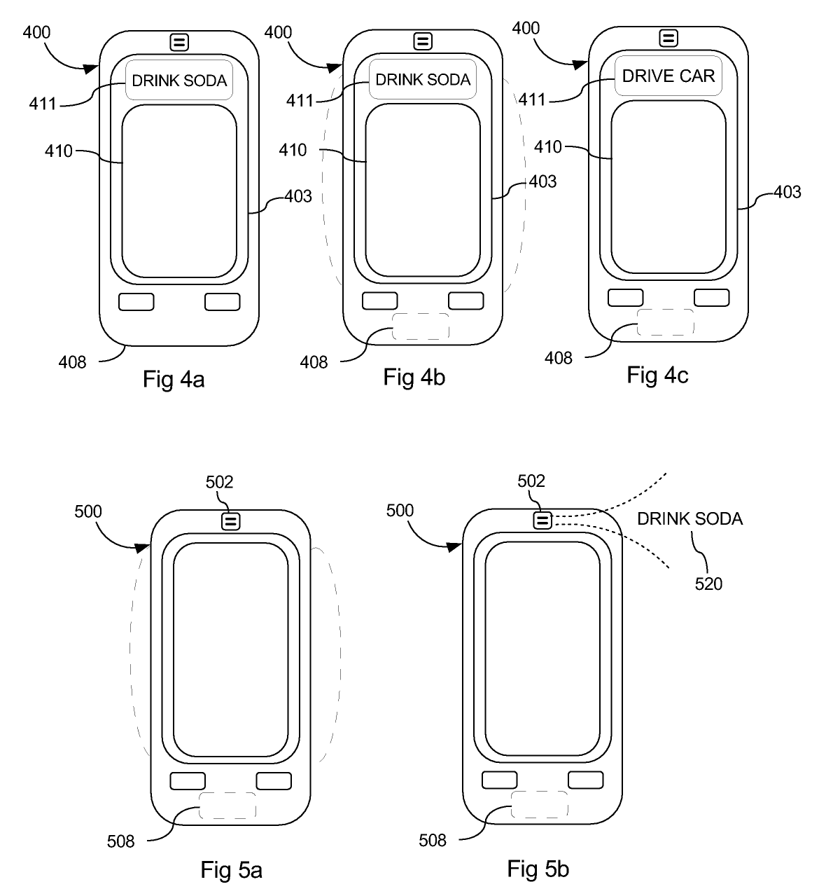

FIGS. 4a-c show a view of an apparatus 400 according to the teachings herein. It should be noted that such an apparatus is not limited to a mobile phone. In particular such an apparatus is capable of displaying graphical data and/or audio data.

The apparatus 400 comprises a motion sensor 408 which is in this embodiment an internal component of the apparatus and not visible. This is indicated by a dashed line.

In FIG. 4a the apparatus (400) currently displays an application window 410 and an advertisement 411 on a display 403. In this example embodiment a statement “DRINK SODA” is displayed as the advertisement 411 enticing a user to purchase a soda. As the apparatus 400 is subjected to a shaking movement (indicated by the arches of FIG. 4B) the motion sensor 408 generates a motion signal in cooperation with the controller (not shown) as is described below and a new advertisement is displayed as can be seen in FIG. 4C where a new statement “DRIVE CAR” is displayed enticing a user to purchase a specific car.

It should be noted that the advertisements 411 shown in this text are highly schematic and are only to be regarded to be examples of possible advertisements. The teachings herein naturally apply to other more complex and advanced advertisements as well.

By switching the displayed advertisement according to shocks exerted to the device he provider is able to make sure that the shown statement is changed according to the use of the phone. Active use will thus cause more advertisements to be shown.

It also enables a user to quickly check what offers are currently available.

As an example a use case s described below. A user is walking through a mall. As the user moves the apparatus (by carrying it) local advertisements are pushed to the phone and displayed accordingly. If the user wants to see another offer he simply shakes the device.

In one embodiment the apparatus is arranged to display new advertisements upon each motion detected which will provide new advertisements for each step or series of steps.

An apparatus as described herein is in one embodiment one of a radio, media player, mobile phone or PDA.

FIGS. 5a-b show a view of an apparatus 500 according to the teachings herein. It should be noted that such an apparatus is not limited to a mobile phone. In particular such an apparatus is capable of providing audio data.

In this embodiment the advertisement is provided as audio data. As a motion signal is generated in response to a detected movement (FIG. 5a) an audio file is played through a playback system such as a loudspeaker 502 of said apparatus (FIG. 5b). Alternatively the audio file is played through a headset of a device such as a mobile phone, media player or radio. In this example embodiment a voice statement “DRINK SODA” 520 is played through the loudspeaker 502 of the apparatus 500 enticing a user to purchase a specific soda.

In an embodiment according to FIG. 5 a user would be presented with audio advertisements presenting some offer or establishment. Such an embodiment is in one embodiment implemented in a car stereo or a portable media player or radio.

In one embodiment the advertisement is provided by displaying an image or video file on a display. The image and the video file are examples of graphic data. Such an embodiment is described in relation to FIG. 4.

In one embodiment the advertisement is provided by both audio data and graphic data.

In one embodiment the advertisement is location specific. In such an embodiment the advertisement can either be pushed to the apparatus by a server or pulled by the apparatus from a server as an area is entered.

In one embodiment the selected advertisement is selected according to a context.

In one embodiment the context is related to the location.

In one embodiment the context is related to recent input or displayed keywords or topics.

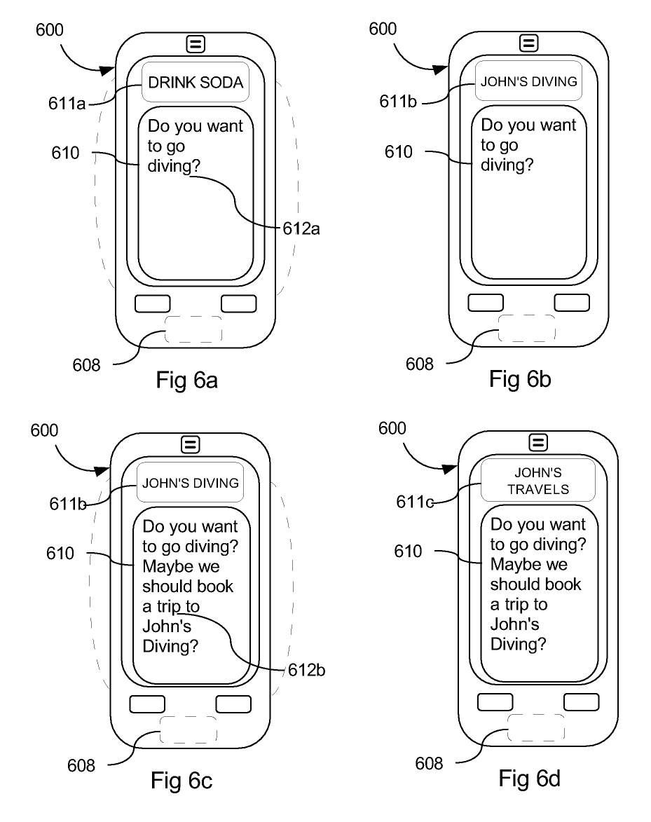

FIGS. 6a-d show a view of an apparatus 600 according to the teachings herein. It should be noted that such an apparatus is not limited to a mobile phone. In particular such an apparatus is capable of providing graphic data.

In FIG. 6a an advertisement 611a is displayed and a user has input the word “diving” 612a in a text message in an application window 610. A controller (not shown) is configured to detect such a word and mark it as a special word in a memory space (not shown). As the apparatus 600 is subjected to a shaking gesture (indicated by the dashed rounded lines) a motion sensor 608 detects this and a motion signal is generated. A controller (not shown) is configured to provide a new advertisement which is selected according to the stored special words and an advertisement 611b for John's Diving is provided accordingly, see FIG. 6B. This enables a user to check for relevant offers while composing the message. In FIG. 6C the user has input the word “trip” 612b and shakes the apparatus 600 and an advertisement 611c for “John's travels” is provided accordingly in FIG. 6D as the motion signal is generated.

In one embodiment all special words 612 are stored in the memory space and in one embodiment only the most recently input special word is stored in the memory space.

Alternatively the controller is configured to parse the text for special words upon receipt of the motion signal.

In this example a user is thus able to check for relevant offers while composing a message to a contact without switching application in a manner that is easy and intuitive to learn.

Such an embodiment enables a user to search for offers relating to a specific word by entering a specific word and then shaking the apparatus.

In one embodiment the context is related to the movement of the apparatus.

In one embodiment the speed that an apparatus is travelling at is detected. The speed can either be detected by the use of a motion sensor measuring the acceleration over time, a built in speedometer, an external speedometer (possibly connected to a car's speedometer) or by sensing the movement of the apparatus in a network. Other methods for determining the speed of the apparatus may be used and are well-known in the art including comparing GPS positions (GPS—Global Positioning System).

In one example an apparatus is determined to be moving at slow speed, possibly representing a user walking, and ads that are relevant for establishments within an area with a radius of 500 meters are shown.

In one example an apparatus is determined to be moving at high speed, possibly representing a user sitting in a car, and ads that are relevant for establishments within an area with a radius of 10.000 meters are shown.

In one embodiment the direction of travel is also taken into account. In the examples above the areas are helical in such a case.

In one embodiment the context is related to the network coverage. A server then determines which offers are most relevant for the user and pushes these first to make sure the apparatus can display these offers in case it should go into an area with poor connectivity where new advertisements can not be pushed to the device.

Another example is that as the apparatus enters an area with a higher than average connection speed advertisements relating to offers that relate to content (such as music or video) downloads are chosen to be displayed.

In one embodiment the capabilities of the apparatus is determined and the advertisements selected accordingly. For example if an apparatus is determined to be able to play video files down loading offers for video content can be displayed. If the apparatus is capable of storing images offers relating to printing jobs, possibly from nearby photo shops, are displayed.

In one embodiment the controller is adapted to determine how quickly an advertisement is cancelled or in other words, how fast the user switches to another advertisement. In such an embodiment the controller can be configured to select advertisements that relate to a context that advertisements that are not switched from also relate to.

In all embodiments described herein the motion signal is generated by a motion sensor. The motion sensor (340, 408) detects a motion of the apparatus (400) and in one embodiment forwards the motion data to a controller (300) and the controller determines whether a motion signal should be generated or not or the motion sensor (340) generates a motion signal which is forwarded to the controller (300) which then uses the motion signal accordingly.

In one embodiment a motion signal for triggering a presentation of an advertisement is generated if the detected motion exceeds a threshold value.

The threshold to be exceeded to generate a motion signal can be related to the sum of shocks integrated over time, the number of shocks detected either in a certain time space or independent of the lapsed time or the threshold represents a shock amplitude that needs to be surpassed to generate the motion signal.

It should be noted that alternatives to an accelerometer such as an optic motion sensor (possibly implemented through the use of a camera) can be used to implement the teachings described herein.

In one embodiment the advertisement represents an offer of a certain rated value. In one embodiment the rated value of an advertisement displayed in response to a motion signal is selected according to an amplitude of the shaking motion.

In one embodiment an advertisement is associated with a highly specific shaking pattern and a user has to perform said shaking pattern to generate a motion signal that will cause the controller to display the special advertisement. In one embodiment the shaking pattern can be used in a game or be the goal of a game.

FIG. 7 shows a flowchart of a method according to an embodiment of the teachings herein. In a first step an advertisement is displayed 710. A motion is detected and a motion signal is received in step 720 and a second advertisement is displayed in step 730 accordingly.

The various aspects of what is described above can be used alone or in various combinations. The teaching of this application may be implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in Personal digital Assistants (PDAs), game consoles, media players, personal organizers, computers or any other device designed for sharing and viewing images.

The teaching of the present application has numerous advantages. Different embodiments or implementations may yield one or more of the following advantages. It should be noted that this is not an exhaustive list and there may be other advantages which are not described herein. For example, one advantage of the teaching of this application is that a provider can easily provide new advertisements to a user and be confident that the user is actively using the apparatus through which the advertisement is provided. Another advantage is that a user can easily search through or for advertisements while being engaged in other activities.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone, it should be appreciated that the teachings of the present application may also be applied to other types of electronic devices, such as media players and palmtop computers and the like. It should also be noted that there are many alternative ways of implementing the methods and apparatuses of the teachings of the present application.

Features described in the preceding description may be used in combinations other than the combinations explicitly described.

Whilst endeavoring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

The term “comprising” as used in the claims does not exclude other elements or steps. The term “a” or “an” as used in the claims does not exclude a plurality. A unit or other means may fulfill the functions of several units or means recited in the claims.

1. An apparatus comprising a controller configured to:
provide a first advertisement statement,
receive a motion signal, and
provide a second advertisement statement in response to receipt of said motion signal.

2. An apparatus according to claim 1, wherein said controller is further configured to provide said advertisement statement as graphic data.

3. An apparatus according to claim 1, wherein said controller is further configured to provide said advertisement statement as audio data.

4. An apparatus according to claim 1, wherein said motion signal represents a shaking gesture.

5. An apparatus according to claim 1, wherein said motion signal represents a threshold being exceeded by the sum of amplitudes of gestures over a time.

6. An apparatus according to claim 1, wherein said first advertisement statement is related to a first context and said second advertisement statement is related to said first context.

7. An apparatus according to claim 6, wherein said first context is related to one of the items in a group comprising: speed of travel, direction of travel, capabilities, network capabilities and time displayed for related advertisements.

8. A method for providing an advertisement comprising
providing a first advertisement statement,
receiving a motion signal, and
providing a second advertisement statement in response to receipt of said motion signal.

9. A method according to claim 8 further comprising providing said advertisement statement as graphic data.

10. A method according to claim 8 further comprising providing said advertisement statement as audio data.

11. A method according to claim 8, wherein said motion signal represents a shaking gesture.

12. A method according to claim 8, wherein said motion signal represents a threshold being exceeded by the sum of amplitudes of gestures over a time.

13. A method according to claim 8, wherein said first advertisement statement is related to a first context and said second advertisement statement is related to said first context.

14. A method according to claim 13, wherein said first context is related to one of the items in a group comprising: speed of travel, direction of travel, capabilities, network capabilities and time displayed for related advertisements.

15. An apparatus comprising means for
providing a first advertisement statement,
means for receiving a motion signal, and
means for providing a second advertisement statement in response to receipt of said motion signal.

16. A computer readable medium comprising software code for
providing a first advertisement statement,
software code for receiving a motion signal, and
software code for providing a second advertisement statement in response to receipt of said motion signal.
